(19) United States
(12) Patent Application Publication
(10) Pub. No.: US 2019/0071355 A1
(43) Pub. Date: Mar. 7, 2019

(54) A CONSTRUCTION BUILDING MATERIAL MIXTURE

(71) Applicant: Yonca INKAYA, Seyhan (TR)

(72) Inventor: Yonca INKAYA, Seyhan (TR)

(21) Appl. No.: 15/772,051

(22) PCT Filed: Oct. 28, 2016
(86) PCT No.: PCT/TR2016/050408

§ 371 Date: Apr. 28, 2018

(30) Foreign Application Priority Data
Oct. 28, 2015 (TR) 2015/13473

(51) Int. Cl. C04B 28/16; C04B 14/06; C04B 7/04; C04B 14/16; C04B 14/28; C04B 14/42; C04B 14/46

(52) U.S. Cl. CPC C04B 28/16; C04B 14/06; C04B 7/04; C04B 2111/27; C04B 14/285; C04B 14/42; C04B 14/46; C04B 14/16

(57) ABSTRACT

The invention is related to a construction building material mixture that is generally used in the construction sector, which is highly waterproof, dustproof, resistant to chipping, shrinking, cracking and whose tensile strength has been increased, and which is efficient and cost efficient. The cost of the mixture is lower and it is more efficient as said construction building material mixture is formed of granule or micron particles of natural gypsum and/or natural hemihydrate gypsum and/or natural anhydrite material.

### CROSS REFERENCE TO THE RELATED APPLICATIONS

This application is the national phase entry of International Application No. PCT/TR2016/050408, filed on Oct. 28, 2016, which claims priority from Turkish Patent Application 2015/13473, filed on Oct. 28, 2015, the entire contents of which are incorporated herein by reference.

### TECHNICAL FIELD

The invention is related to a construction building material mixture that is generally used in the construction sector, which is highly waterproof, dustproof, resistant to chipping, shrinking, cracking and whose tensile strength has been increased, and which is efficient and cost efficient. The cost of the mixture is lower and it is more efficient as said construction building material mixture is formed of granule or micron particles of natural gypsum and/or natural hemihydrate gypsum and/or natural anhydride material.

### BACKGROUND

Several construction chemicals and other construction materials such as plasters, cement based plasters, joint fillers, ceramic adhesives and insulation plasters which are used during the production and restoration works of constructions are included in the construction building sector. Developments have been carried out in the art in order to efficiently make use of construction chemicals and other construction material mixtures used in the construction sector.

A construction chemical composition is described in the United States Patent document numbered US 2013 256579 which is an improvement of the known state of the art. It is described that the mixture comprises anhydride material ranged between 30% to 90%, cement between 0% to 40%, light or heavy filler materials between 0% to 70%, activator admixture materials between 1% to 10%, setting and strength regulating materials between 1% to 20% and thickeners between 1% to 12%. However, the strength of the mixture is low due to the density and other structural differences of the unnatural synthetic anhydride material contained inside the mixture and higher amounts of chemical admixtures, strength regulating materials, mineral fillers and binders need to be used in order to reach the same targeted tensile strengths.

As it has already been mentioned above, it is described that the construction chemical and construction material mixtures of the known state of the art can be provided as low cost, preferably highly waterproof, dustproof mixtures which are resistant to chipping, shrinking, cracking and which have increased tensile strength, as said mixture comprises granule or micron particles of natural gypsum and/or natural hemihydrate gypsum and/or natural anhydride materials and mixtures thereof.

### DETAILED DESCRIPTION

A construction building material mixture subject to the invention comprises; cement material between the range of 0 to 45% by weight which increases the binding of the mixture, calcite and/or marble powder and/or limestone powder and/or silica sand material between 0 to 85% by weight which increases the saturity of the mixture, basaltic pumice and/or white limestone material between the range of 0 to 40% by weight which provides heat insulation and strength to the mixture and makes the mixture lighter , pearlite material between the range of 0 to 25% by weight which increases the heat insulation feature of the mixture and makes said mixture lighter by providing volume, fibreglass and/or stone wool material between the range of 0 to 20% by weight which increases the heat and sound permeability, a setting regulator, water repellent, anti foamer, cracking preventer, thickener, water retainer, drying retarder, adhesive, slagging preventer, foaming agents and/or swelling agents, white and coloured pigments, various fibres, bentonit, slaked lime, other mineral fillers and binders, activator admixtures, plasticizers, air entrainers, heat insulators, sound insulators and admixtures which provide water impermeability between the range of 0 to 25% by weight and
natural gypsum and/or natural hemihydrate gypsum and/or natural anhydride material and mixtures thereof between the range of 5 to 98% by weight, having granule or micron particle structures ranged above 0 value or below 25 mm and having a crystallization water content between the range of 0.05 to 10%.

In order to bring the 0.05 to 10% amount of crystallized water, inside the construction building material mixture subject to the invention to required levels, natural gypsum and/or hemi hydride gypsum and/or anhydride material or mixtures thereof having suitable ratios by weight are turned into granule or micron particles, above 0 value or below 25 mm and after said particles are sieved to have suitable particle granulation ranges to be used in the end product without modifying the natural structure thereof and then, other chemical admixtures, binders and mineral fillers are added to the mixture.

The binding feature and resistance of the material is increased by means of the natural gypsum and/or hemihydrate and/or natural anhydrite material comprising granule or micron sized particles ranged above 0 value and below 25 mm, and having 0.05 to 10% of crystallized water suitable by weight located inside the construction building material mixture subject to the invention and the mixture can be provided as low cost, preferably highly waterproof, dustproof mixture which is also resistant to chipping, shrinking and cracking and which has increased tensile strength.

1. A construction building material mixture comprising:
a cement material between a range of 0 to 45% by weight to increase the binding of the mixture,
calcite and/or marble powder and/or limestone powder and/or silica sand material between 0 to 85% by weight to increase the saturity of the mixture,
basaltic pumice and/or white limestone material between the range of 0 to 40% by weight to provide heat insulation and strength to the mixture and make the mixture lighter,
pearlite material between the range of 0 to 25% by weight to increase the heat insulation feature of the mixture and make said mixture lighter by providing volume,
fibreglass and/or stone wool material between the range of 0 to 20% by weight to increase the heat and sound permeability,
a setting regulator, water repellent, anti foamer, cracking preventer, thickener, water retainer, drying retarder, adhesive, slagging preventer, foaming agents and/or swelling agents, white and coloured pigments, various fibres, bentonit, slaked lime, mineral fillers and binders, activator admixtures, plasticizers, air entrainers, heat insulators, sound insulators and admixtures to provide water impermeability between the range of 0 to 25% by weight and
natural gypsum and/or natural hemihydrate gypsum and/or natural anhydride material and mixtures thereof between the range of 5 to 98% by weight, having granule or micron particle structures ranged above 0 value or below 25 mm and having a crystallization water content between the range of 0.05 to 10%.
